(19) United States
(12) Patent Application Publication
(10) Pub. No.: US 2026/0319409 A1
(43) Pub. Date: Oct. 15, 2026

(54) IMAGE FORMING APPARATUS, CONTROL METHOD, AND NON-TRANSITORY COMPUTER-READABLE RECORDING MEDIUM

(71) Applicant: Konica Minolta Inc., Tokyo (JP)

(72) Inventors: Masanori Murakami, Toyohashi-shi (JP); Noritoshi Hagimoto, Toyohashi-shi (JP); Sayaka Morita, Gamagori-shi (JP)

(73) Assignee: Konica Minolta Inc., Tokyo (JP)

(21) Appl. No.: 19/291,032

(22) Filed: Aug. 5, 2025

(30) Foreign Application Priority Data
Aug. 6, 2024 (JP) 2024-130050

(51) Int. Cl. G03G 15/00

(52) U.S. Cl. CPC G03G 15/5029; G03G 2215/00742

(57) ABSTRACT

An image forming apparatus includes a measurement sensor that measures a physical property value of a medium, a controller that determines a process condition based on the physical property value measured by the measurement sensor and controls an image forming operation on the medium by applying the determined process condition, and a storage that stores the physical property value measured by the measurement sensor and the process condition determined by the controller in association with each other. Upon detecting that the physical property value of the medium newly measured by the measurement sensor is within a predetermined range from the physical property value stored in the storage, the controller identifies the process condition associated with the physical property value within the predetermined range.

### CROSS REFERENCE TO RELATED APPLICATIONS

This application is based on Japanese Patent Application No. 2024-130050 filed on Aug. 6, 2024, the contents of which are incorporated herein by reference.

### BACKGROUND OF THE INVENTION

### Technical Field

The present invention relates to an image forming apparatus, a control method, and a non-transitory computer-readable recording medium. In particular, the present invention relates to a technique for setting optimum process conditions in accordance with a medium used in an image forming apparatus.

### Description of Related Art

In an image forming apparatus using an electrophotographic method, processing conditions such as a processing speed vary depending on a type of a medium. For example, in the case of a medium having a small basis weight, an image can be completely fixed on the medium in a fixing device even when the medium is conveyed at a high speed. However, in the case of a medium having a large basis weight, when the medium is conveyed at a high speed, sufficient fixing processing is not performed in the fixing device, and the fixed state of the image on the medium becomes incomplete. Therefore, a conventional image forming apparatus is configured to measure the basis weight of a medium and set process conditions such as a processing speed (e.g., Japanese Unexamined Patent Publication No. JP2020-97170A).

However, a measurement error occurs in the basis weight of the medium. If a measurement error occurs near a threshold value at which process conditions are switched, the process conditions may be switched between mediums although the mediums are originally of the same type. Therefore, there is a problem that low speed conveyance is set as a process condition although the medium is originally capable of high speed conveyance, and productivity decreases.

### SUMMARY OF THE INVENTION

The present invention has been devised in order to solve the above described problems. That is, an object of the present invention is to provide an image forming apparatus, a control method, and a non-transitory computer-readable recording medium that can set appropriate process conditions by reducing the influence of a measurement error.

A first subject of the present invention is directed to an image forming apparatus.

According to one aspect of the first subject, the image forming apparatus includes a measurement sensor that measures a physical property value of a medium, a controller that determines a process condition based on the physical property value measured by the measurement sensor, and controls an image forming operation on the medium by applying the determined process condition, and a storage that stores the physical property value measured by the measurement sensor and the process condition determined by the controller in association with each other. Upon detecting that the physical property value of the medium newly measured by the measurement sensor is within a predetermined range from the physical property value stored in the storage, the controller identifies the process condition associated with the physical property value within the predetermined range.

A second subject of the present invention is directed to a control method of an image forming apparatus including a measurement sensor that measures a physical property value of a medium.

According to one aspect of the second subject, the control method includes determining a process condition based on the physical property value measured by the measurement sensor, controlling an image forming operation on the medium by applying the determined process conditions, and storing, in a predetermined storage, the physical property value measured by the measurement sensor and the determined process condition in association with each other. Upon detecting that the physical property value of the medium newly measured by the measurement sensor is within a predetermined range from the physical property value stored in the storage, the control method identifies the process condition associated with the physical property value within the predetermined range.

A third subject matter of the present invention is directed to a non-transitory computer-readable storage medium storing a program to be executed by an image forming apparatus including a measurement sensor that measures a physical property value of a medium.

According to an aspect of the third subject, the program causes the image forming apparatus to execute determining a process condition based on the physical property value measured by the measurement sensor, controlling an image forming operation on the medium by applying the determined process condition; and storing the physical property value measured by the measurement sensor and the determined process condition in a predetermined storage in association with each other. Upon detecting that the physical property value of the medium newly measured by the measurement sensor is within a predetermined range with respect to the physical property value stored in the storage, the image forming apparatus executes identifying the process condition associated with the physical property value within the predetermined range.

### BRIEF DESCRIPTION OF THE DRAWINGS

The advantages and features provided by one or more embodiments of the invention will become more fully understood from the detailed description given herein below and the appended drawings which are given by way of illustration only, and thus are not intended as a definition of the limits of the present invention.

FIG. 1 is a diagram illustrating a schematic configuration of an image forming apparatus;

FIG. 2 is a block diagram illustrating a functional configuration of a controller;

FIG. 3 is a diagram illustrating an example of physical property value data;

FIG. 4 is a diagram illustrating an example of a method of determining process conditions by a determining section;

FIG. 5 is a flowchart illustrating an example of a processing procedure performed by a controller;

FIG. 6 is a flowchart illustrating an example of a detailed processing procedure of process condition determination processing;

FIG. 7 is a flowchart illustrating an example of a detailed processing procedure of the job execution processing

FIG. 8 is a flowchart illustrating an example of a detailed processing procedure of process condition inspection processing;

FIG. 9 is a diagram illustrating a physical property value when a sheet thickness and a moisture amount of a medium are measured;

FIG. 10 is a block diagram illustrating a functional configuration of an image forming apparatus in a third embodiment; and

FIG. 11 is a diagram illustrating another example of physical property value data.

### DETAILED DESCRIPTION OF EMBODIMENTS

Hereinafter, one or more embodiments of the present invention will be described with reference to the drawings. However, the scope of the invention is not limited to the disclosed embodiments. Note that in the embodiments described below, common elements are denoted by the same reference signs, and redundant description thereof is omitted.

### First Embodiment

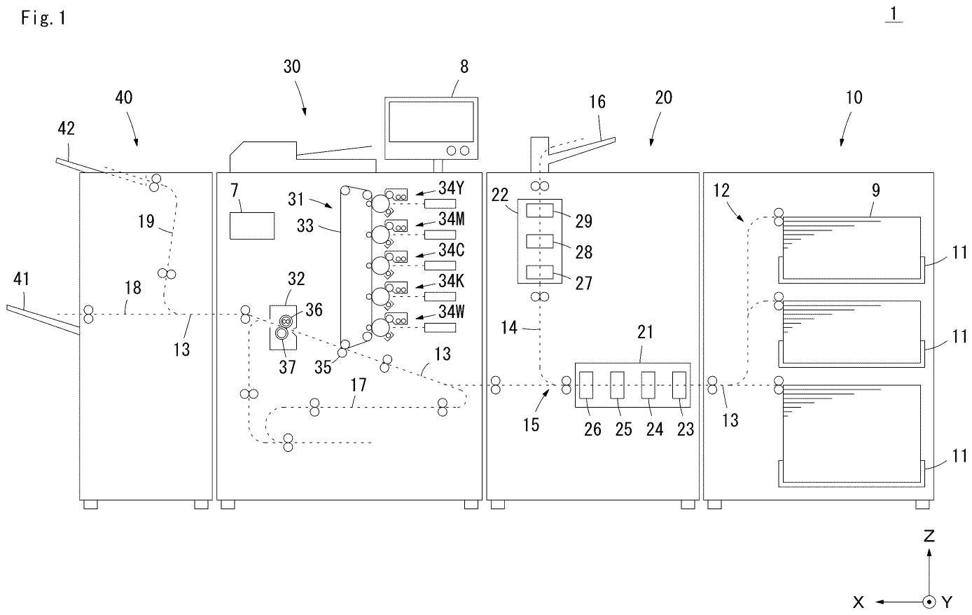

FIG. 1 is a diagram illustrating a schematic configuration of an image forming apparatus 1 according to the first embodiment of the present disclosure. The image forming apparatus 1 includes a sheet feed unit (or sheet feeder) 10, a measurement unit 20, an image forming unit 30, and a sheet ejection unit (or sheet ejector) 40. The sheet feed unit 10, the measurement unit 20, the image forming unit 30, and the sheet ejection unit 40 are arranged in order along an X direction illustrated in FIG. 1 and are mechanically and electrically connected to each other. Upon start of execution of a print job, the image forming apparatus 1 feeds a sheet-like medium 9, such as a printing sheet, from the sheet feed unit 10 and conveys the medium 9 in an X direction. That is, the medium 9 fed from the sheet feed unit 10 is sequentially conveyed through the measurement unit 20, the image forming unit 30, and the sheet ejection unit 40. The image forming apparatus 1 forms an image on the medium 9 when the medium 9 being conveyed passes the image forming unit 30. The medium 9 on which the image has been formed is ejected to one of the sheet ejection trays 41 and 42 by the sheet ejection unit 40.

The sheet feed unit 10 includes a plurality of sheet feed trays 11. In each sheet feed tray 11, a plurality of mediums (media) 9 of the same type are stored in a stacked state. Note that the plurality of sheet feed trays 11 may store different types of mediums 9. The sheet feed unit 10 includes a sheet feed and conveyance section 12. The sheet feed and conveyance section 12 picks up the mediums 9 one by one from the sheet feed tray 11 designated by the job among the plurality of sheet feed trays 11 and sends the medium 9 to the conveyance path 13. The conveyance path 13 is a path for conveying the mediums 9 one by one, and is formed so as to communicate from the sheet feed unit 10 to the sheet ejection unit 40.

The measurement unit 20 measures physical property values of the medium 9 fed from the sheet feed unit 10. The measurement unit 20 has a branch section 15 in the conveyance path 13 provided therein, and the conveyance path 13 is branched into two paths at the branch section 15. One of the paths is a conveyance path 13 that guides the medium 9 conveyed from the sheet feed unit 10 to the image forming unit 30. The other path is a conveyance path 14 for ejecting the medium 9 conveyed from the sheet feed unit 10 to a purge tray 16 provided on top of the measurement unit 20 without supplying the medium 9 to the image forming unit 30.

The measurement unit 20 includes two measurement sections (or measurement sensors) 21 and 22. These two measurement sections 21 measure physical property values of the medium 9. There are various types of physical property values of the medium 9. For example, the physical property values of the medium 9 include sheet thickness, basis weight, size, moisture percentage, stiffness, surface property, and resistance value. The measurement sections 21 and 22 measure their physical property values.

The measurement section 21 is provided, for example, on the upstream side of the branch section 15. The measurement section 21 measures the physical property value of the medium 9 while the medium 9 loaded from the sheet feed unit 10 is being conveyed along the conveyance path 13. The measurement section 21 measures the sheet thickness, the basis weight, the size, and the moisture percentage among the physical property value of the medium 9. The measurement section 21 includes a sheet thickness sensor 23, a size detection sensor 24, a basis weight sensor 25, and a moisture percentage sensor 26. The sheet thickness sensor 23, the size detection sensor 24, the basis weight sensor 25, and the moisture percentage sensor 26 can measure their respective physical property values while the conveyance of the medium 9 is continued without stopping the conveyance of the medium 9.

The sheet thickness sensor 23 includes, for example, a pair of rollers disposed one above the other with the conveyance path 13 interposed therebetween. When the medium 9 passes through, the pair of rollers change an inter-axis distance depending on the sheet thickness. The sheet thickness sensor 23 measures the sheet thickness by detecting a change in the inter-axis distance. The size detection sensor 24 is configured by, for example, a contact image sensor, and measures the size of the medium 9 in the X direction and the Y direction. The basis weight sensor 25 measures the basis weight of the medium 9 by, for example, irradiating the medium 9 with light and detecting the specular reflectance, the diffuse reflectance, and the transmittance. Provided that the basis weight sensor 25 may be formed of a weight sensor that directly measures the weight of the medium 9. The moisture percentage sensor 26 irradiates, for example, the medium 9 with light having a wavelength that is absorbed by moisture and light having a wavelength that is not absorbed by moisture, and detects the reflectance of the light. The moisture percentage sensor 26 measures the moisture percentage of the medium 9 based on the difference between the reflectance. The measurement section 21 sequentially measures a plurality of physical property values such as the basis weight while the medium 9 is being conveyed along the conveyance path 13.

The measurement section 22 is provided, for example, on the conveyance path 14 extending toward the purge tray 16. The measurement section 22 measures the stiffness, the surface property, and the resistance value among the physical property value of the medium 9. The measurement section 22 includes a stiffness sensor 27, a surface property sensor 28, and a resistance sensor 29. The stiffness sensor 27 measures the stiffness of the medium 9. The surface property sensor 28 measures the glossiness of the surface of the medium 9. The resistance sensor 29 measures the resistance value of the medium 9 by applying a voltage to the medium 9. When the medium 9 is conveyed to the conveyance path 14, the measurement section 22 temporarily stops the conveyance of the medium 9, and measures the physical property value of the medium 9 while the medium 9 is stopped.

After measuring the physical property value with each of the stiffness sensor 27, the surface property sensor 28, and the resistance sensor 29, the measurement section 22 restarts the conveyance of the medium 9 and discharges the medium 9 to the purge tray 16. That is, the medium 9 whose physical property value has been measured by the measurement section 22 is not conveyed to the image forming unit 30.

The image forming unit 30 forms an image on the medium 9 conveyed from the measurement unit 20. The image forming unit 30 includes an image forming section (or image forming device) 31, a fixing device 32, a controller 7, and an operation panel 8. The image forming section 31 and the fixing device 32 form an image on the medium 9 conveyed along the conveyance path 13 and fix the image on the medium 9.

The image forming section 31 includes an intermediate transfer belt 33, a plurality of imaging units 34Y, 34M, 34C, 34K, and 34 W, and a secondary transfer roller 35.

Intermediate transfer belt 33 is formed of an endless belt, and circulates in a predetermined rotation direction. The intermediate transfer belt 33 primarily transfers and conveys images generated by the plurality of imaging units 34Y, 34M, 34C, 34K, and 34W.

The plurality of imaging units 34Y, 34M, 34C, 34K, and 34W are arranged so as to be in contact with the intermediate transfer belt 33 at predetermined intervals. The plurality of imaging units 34Y, 34M, 34C, 34K, and 34W form images in respective colors of yellow (Y), magenta (M), cyan (C), black (K), and a spot color (W). Each of the imaging units 34Y, 34M, 34C, 34K, and 34W includes a rotating photosensitive drum, and a charging device, an exposure device, and a developing device are provided around the photosensitive drum. The charging device charges the surface of the photosensitive drum to a predetermined charge. The exposure device exposes the surface of the charged photosensitive drum so as to form an electrostatic latent image in accordance with the image data. The developing device applies a developer containing toner to the surface of the photosensitive drum and develops the electrostatic latent image with the toner. Thus, an image is formed on the surface of the photosensitive drum.

The imaging unit 34Y forms a toner image of Y color and primarily transfers the toner image to the intermediate transfer belt 33. The imaging unit 34M forms a toner image of M color and primarily transfers the toner image onto the intermediate transfer belt 33. The imaging unit 34C forms a toner image of C color and primarily transfers it to the intermediate transfer belt 33. The imaging unit 34K forms a toner image of K color and primarily transfers the toner image onto the intermediate transfer belt 33. The imaging unit 34W performs primary transfer of a toner image of a spot color onto the intermediate transfer belt 33. The imaging unit 34W according to the present embodiment forms a white image as the spot color (W). The image forming section 31 may not include the imaging unit 34W for the spot color (W).

The plurality of imaging units 34Y, 34M, 34C, 34K, and 34W primarily transfer the images in the respective colors to the intermediate transfer belt 33 in a superimposed manner. Therefore, when the intermediate transfer belt 33 passes through the position of the most downstream imaging unit 34W, a color image is formed on the surface of the intermediate transfer belt 33. The intermediate transfer belt 33 conveys the color image toward a position of the secondary transfer roller 35.

The secondary transfer roller 35 is provided in a conveyance path 13 through which the medium 9 is conveyed, and is in contact with the surface of the intermediate transfer belt 33. The secondary transfer roller 35 presses the medium 9, which is conveyed along the conveyance path 13, against the intermediate transfer belt 33 and is applied with a predetermined voltage, thereby secondarily transferring the image held by the intermediate transfer belt 33 onto the surface of the medium 9.

The medium 9 onto which the image has been transferred by the secondary transfer roller 35 is conveyed to the fixing device 32. The fixing device 32 includes a heating roller 36 and a pressure roller 37, and forms a nip portion in which the heating roller 36 and the pressure roller 37 are in contact with each other. The fixing device 32 conveys the medium 9 to the nip portion, and fixes an image on the medium 9 by performing a fixing process including a heating process and a pressing process when the medium 9 passes through the nip portion.

The image forming unit 30 is provided with a reverse path 17 that reverses the front and back of the medium 9 that has passed through the fixing device 32 and transports again the medium 9 to the upstream side of the secondary transfer roller 35. In a case of forming images on both the front and back faces of the medium 9, after an image is formed on one face of the medium 9, the image forming unit 30 conveys the medium 9 to a reverse path 17 to reverse the front and back faces, and forms an image on the other face of the medium 9.

The sheet ejection unit 40 receives the medium 9 on which an image has been formed by the image forming unit 30, and ejects the medium 9 to the sheet ejection tray 41 or 42. The sheet ejection unit 40 internally branches the conveyance path 13 into two routes 18 and 19. The path 18 guides the medium 9 to the sheet ejection tray 41 and ejects the medium 9. The path 19 guides the medium 9 to the sheet ejection tray 42 and ejects the medium 9.

The controller 7 comprehensively controls execution operation of jobs in the image forming apparatus 1. That is, the controller 7 controls the operation of the sheet feed unit 10, the measurement unit 20, the image forming unit 30, and the sheet ejection unit 40. For example, the controller 7 receives a user's job setting operation via the operation panel 8. Next, the controller 7 controls execution of the job specified by the user.

Before starting execution of a job specified by a user, the controller 7 determines process conditions appropriate for the job. The process conditions are conditions for appropriately forming an image on the medium 9. The process conditions include a process speed that defines a conveyance speed of the medium 9 and a speed of the intermediate transfer belt 33, a fixing temperature at the time of performing a heating process in the fixing device 32, and the like. For example, in a case where the medium 9 is thick paper, in order to appropriately fix an image on the medium 9 in the fixing device 32, it is necessary to perform a fixing process at a higher temperature for a longer time than in the case of thin paper. Therefore, the process conditions in a case where the medium 9 is thick paper are different from the process conditions in a case where the medium 9 is thin paper. In particular, in a case where the medium 9 is thick paper, the process speed is slower than in a case of thin paper.

In order to determine the process conditions, the controller 7 feeds the medium 9 from the sheet feed tray 11 specified in the job. The medium 9 is conveyed from the branch section 15 to the conveyance path 14 in the measurement unit 20, and is ejected to the purge tray 16. At this time, the measurement unit 20 measures the physical property value of the medium 9 with each of the measurement sections 21 and 22. Next, the controller 7 determines process conditions on the basis of the physical property value of the medium 9 measured by the measurement unit 20. Next, the controller 7 applies the determined process conditions and starts execution of the job. Hereinafter, such an operation of the controller 7 will be described in detail.

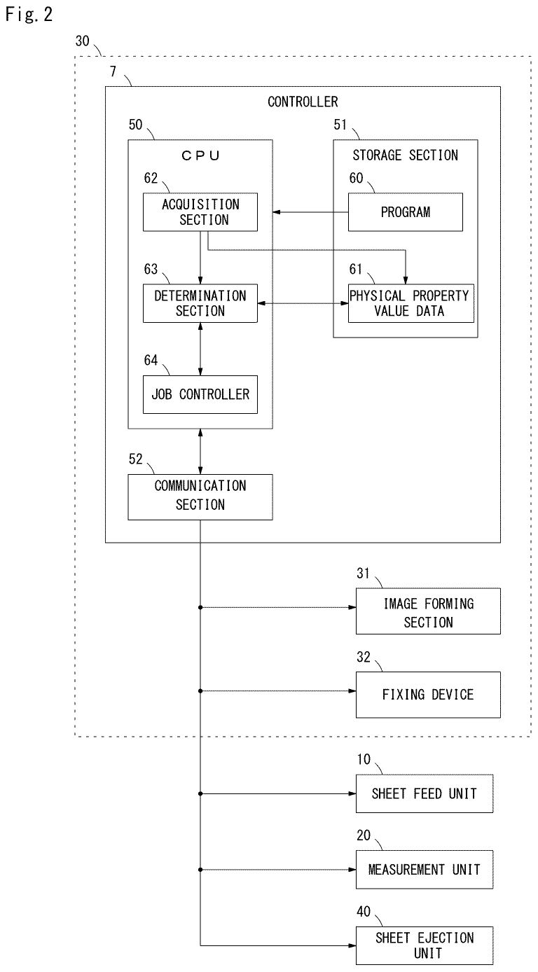

FIG. 2 is a block diagram illustrating the functional configuration of the controller 7. The controller 7 includes a CPU50, a storage section (or storage) 51, and a communication section (or communication interface) 52. The CPU50 is a hardware processor that reads and executes the program 60 stored in the storage section 51. The storage section 51 is a nonvolatile storage device constituted by a hard disk drive (HDD) or a solid-state drive (SSD). A program 60 to be executed by the CPU50 is stored in the storage section 51 in advance. Furthermore, the storage section 51 stores physical property value data 61 in which physical property value of the medium 9 measured by the measurement sections 21 and 22 of the measurement unit 20 are accumulated. The communication section 52 performs communication for the controller 7 to control the operation of each section of the image forming apparatus 1.

As illustrated in FIG. 2, the CPU50 functions as an acquisition section 62, a determination section 63, and a job controller 64 by executing the program 60.

The acquisition section 62 functions before start of execution of a job, and operates the sheet feed unit 10 and the measurement unit 20. The acquisition section 62 feeds at least one sheet of the medium 9 from the sheet feed tray 11 specified in the job, and conveys the medium 9 to the measurement unit 20. The acquisition section 62 drives the branch section 15 of the measurement unit 20 to switch to a state in which the medium 9 is conveyed from the branch section 15 to the conveyance path 14.

When the medium 9 fed from the sheet feed unit 10 passes through the measurement section 21, the acquisition section 62 drives each sensor included in the measurement section 21 to acquire the physical property value of the medium 9. That is, the acquisition section 62 acquires the sheet thickness, basis weight, size, and moisture percentage of the medium 9.

When the medium 9 is conveyed to the conveyance path 14, the acquisition section 62 temporarily stops the conveyance of the medium 9 at the detection position of each sensor included in the measurement section 22. The acquisition section 62 then drives each sensor included in the measurement section 22 to acquire the physical property value of the medium 9. That is, the acquisition section 62 acquires the stiffness, the surface property, and the resistance value of the medium 9. Upon acquiring the physical property value from the measurement section 22, the acquisition section 62 resumes conveyance of the medium 9 in the conveyance path 14 and ejects the medium 9 into the purge tray 16.

The determination section 63 functions before the start of execution of a job, similarly to the acquisition section 62. The determination section 63 analyzes the physical property value of the medium 9 acquired by the acquisition section 62 and determines the process condition suitable for the medium 9 conveyed during the execution of the job. At this time, the determination section 63 reads the physical property value data 61 from the storage section 51. The physical property value data 61 is data in which physical property values collected during execution of past jobs are accumulated and recorded.

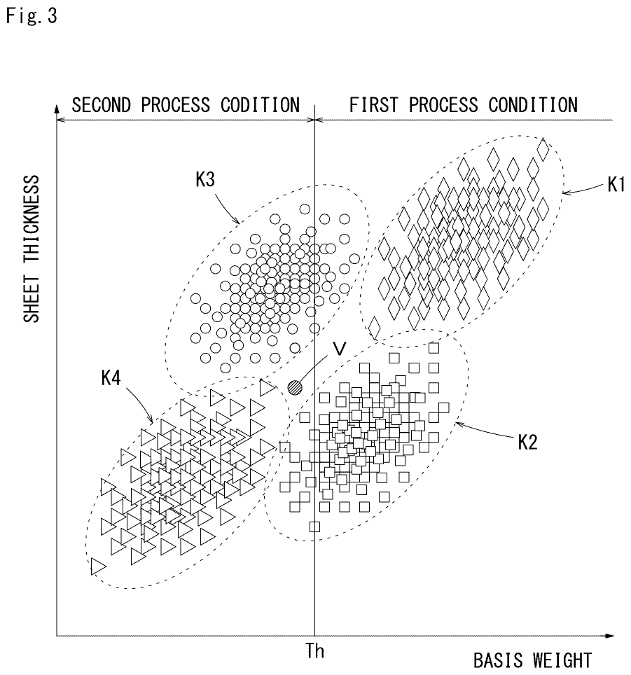

FIG. 3 is a view illustrating an example of physical property value data 61. The physical property value data 61 is data in which physical property values measured one by one by the measurement section 21 every time the medium 9 is conveyed during the execution of the job are accumulated, and is data in which process conditions applied during the execution of the job are associated with the respective physical property value. The example of FIG. 3 illustrates the relationship between the basis weight and the sheet thickness among the plurality of physical property values. The physical property value data 61 shown in FIG. 3 stores information relating to four types of medium 9.

For example, the medium 9 of the first type K1 is a medium on which a job is executed in a state in which the first process condition is applied. The medium 9 of the second type K2 is also a medium on which a job is executed in a state in which the first process condition is applied. The first process condition is, for example, a condition in which 225 mm/s is applied as the processing speed.

The medium 9 of the third type K3 is a medium on which a job is executed in a state in which the second process condition is applied. The medium 9 of the fourth type K4 is also a medium on which a job is executed in a state in which the second process condition is applied. The second process condition is, for example, a condition in which 340 mm/s is applied as the processing speed. Therefore, when the second process condition is applied, the execution efficiency of the job is higher than when the first process condition is applied.

The first process condition and the second process condition are switched by, for example, a threshold value Th set for the basis weight of the medium 9. When the basis weight of the medium 9 is equal to or larger than the threshold value Th, the first process condition is adopted as the process condition during job execution. When the basis weight of the medium 9 is less than the threshold value Th, the second process condition is adopted as the process condition during job execution.

Meanwhile, when the measurement section 21 measures the physical property values of the mediums 9 one by one during the execution of the job, as illustrated in FIG. 3, a spread occurs in the physical property value distribution due to a measurement error. For example, the medium 9 of the second type K2 are distributed across the threshold value Th with respect to the basis weight. The medium 9 of the third type K3 are also distributed across the threshold value Th with respect to the basis weight.

Therefore, when the physical property value V of at least one sheet of the medium 9 is acquired by the acquisition section 62 before the start of the execution of the job, the determination section 63 determines which of the physical property value distributions of the plurality of types K1 to K4 includes the physical property value V. For example, the determination section 63 statistically analyzes the physical property value V and the physical property value distributions of the plurality of types K1 to K4 to identify the physical property value distribution to which the physical property value V belongs. To be specific, the determination section 63 calculates the distances between the physical property value V and the physical property value distributions of the respective types K1 to K4, and identifies the physical property value distributions for which the calculated distances are within a predetermined range. If there are a plurality of physical property value distributions within the predetermined range, the determination section 63 identifies the physical property value distribution at the shortest distance. Next, the determination section 63 determines that the process conditions associated with the identified distribution of physical property value are the optimum process conditions for the medium 9 when the job is executed.

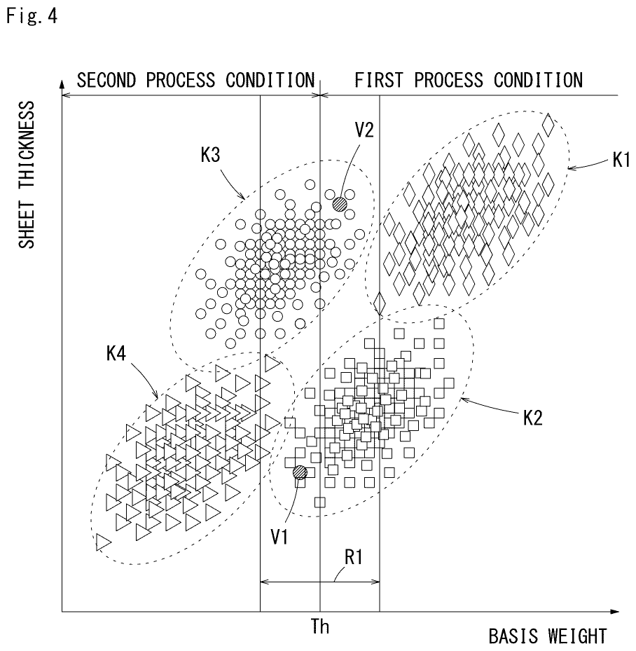

FIG. 4 is a diagram illustrating an example of a method of determining process conditions by the determination section 63. For example, when the physical property value acquired by the acquisition section 62 is the physical property value V1 illustrated in FIG. 4, the determination section 63 identifies that the physical property value distribution within a predetermined range with respect to the physical property value V1 is the physical property value distribution of the second type K2. Then, the determination section 63 identifies that the process condition applied at the time of the job execution of the medium 9 of the second type K2 is the first process condition, and identifies the first process condition as the process condition applied to the job execution of the medium 9 of the physical property value V1.

If the physical property value V1 acquired by the acquisition section 62 is simply compared with the thresholds Th, the determination section 63 determines the second process condition as the process condition optimal for the medium 9 of the physical property value V1. However, such a determination by simple comparison may be an erroneous determination due to the influence of a measurement error. Therefore, in order to prevent erroneous determination due to measurement errors, the determination section 63 compares the physical property value V1 with physical property value distributions collected during execution of a job in the past, thereby identifying a process condition optimal for the medium 9 of the physical property value V1. As a result, it is determined that the physical property value V1 belongs to the physical property value distribution of the medium 9 of the second type K2, and the first process condition is identified.

Further, for example, when the physical property value acquired by the acquisition section 62 is the physical property value V2 illustrated in FIG. 4, the determination section 63 identifies that the physical property value distribution within a predetermined range with respect to the physical property value V2 is the physical property value distribution of the third type K3. Then, the determination section 63 specifies that the process condition applied at the time of the job execution of the medium 9 of the third type K3 is the second process condition, and identifies the second process condition as the process condition applied to the job execution of the medium 9 of the physical property value V2.

If the physical property value V2 acquired by the acquisition section 62 are simply compared with the thresholds Th, the determination section 63 identifies the first process conditions as the process conditions optimal for the medium 9 having the physical property value V2. However, such a determination by simple comparison may be an erroneous determination due to the influence of a measurement error. Therefore, in order to prevent erroneous determination due to measurement errors, the determination section 63 compares the physical property value V2 with physical property value distributions collected during execution of a job in the past, thereby determining process conditions optimal for the medium 9 of the physical property value V2. As a result, it is determined that the physical property value V2 belongs to the physical property value distribution of the medium 9 of the third type K3, and the second process condition is identified.

Here, the determination section 63 may compare the physical property values V1 and V2 acquired by the acquisition section 62 with the distribution of physical property values collected during the execution of a past job only when the physical property values V1 and V2 are within a predetermined range R1 relative to the thresholds Th. In other words, when the physical property values V1 and V2 acquired by the acquisition section 62 are outside the predetermined range R1 with respect to the thresholds Th, the determination section 63 may identify the process conditions by simply comparing the physical property values V1 and V2 with the thresholds Th. Thus, there is an advantage that it is possible to shorten the time required for comparing the physical property values V1 and V2 acquired by the acquisition section 62 with the physical property value distributions collected during the execution of the past jobs.

Upon identifying the process conditions based on the physical property value of the medium 9 fed before the start of the execution of the job, the determination section 63 brings the job controller 64 into operation. Next, the determination section 63 notifies the job controller 64 of the determined process conditions. The process conditions notified at this time include a processing speed and a fixing temperature.

The job controller 64 applies the process conditions identified by the determination section 63, and starts execution of the job. That is, the job controller 64 sets the processing speed depending on the type of the medium 9 to be used in the job, and also sets the fixing temperature depending on the type of the medium 9. When starting execution of the job, the job controller 64 sends a switching instruction for the branch section 15 to the measurement unit 20. Thus, the measurement unit 20 drives the branch section 15 to switch to a state of conveying the medium 9 conveyed from the sheet feed unit 10 to the image forming unit 30. Then, the job controller 64 causes the sheet feed unit 10 to start the sheet feeding operation of the medium 9 in a state in which the process condition identified by the determination section 63 is applied, and controls the image forming operation on the medium 9.

When the execution of the job is started by the job controller 64, the acquisition section 62 drives the measurement section 21 of the measurement unit 20 and acquires the physical property value of the medium 9 when the medium 9 passes through the position of each sensor included in the measurement section 21. When a plurality of mediums 9 are continuously conveyed during the execution of a job, the acquisition section 62 sequentially acquires the physical property values of the plurality of mediums 9. Then, the acquisition section 62 accumulates and stores the physical property values acquired during the execution of the job in the physical property value data as the physical property value related to the medium 9 of the same type. At this time, the acquisition section 62 stores the process conditions identified by the determination section 63 in association with the physical property value. The physical property value acquired during the execution of the job also includes a measurement error. Therefore, the physical property value of the plurality of mediums 9 measured during the execution of the job are not the same value. That is, a set of physical property values collected during the execution of a job forms a physical property value distribution having a certain extent of spread.

When the execution of the job by the job controller 64 ends, the determination section 63 functions again in the CPU50. The determination section 63 then tests whether the process conditions applied during the execution of the current job were appropriate. For example, the determination section 63 performs a significant difference test between the physical property value distribution of the mediums 9 collected during the execution of the current job and the physical property value distribution determined to be at a distance closest to the physical property value V acquired before the execution of the job. Based on the result of the significant difference test, the determination section 63 identifies whether or not the medium 9 indicated by the physical property value distributions collected during the execution of the current job is the same type as the medium 9 indicated by the physical property value distribution determined to be at the closest distance to the physical property value V acquired before the execution of the job.

As a result, when it is determined that the mediums 9 are of the same type, the determination section 63 determines that the process condition applied during the execution of the current job is appropriate. In this case, the determination section 63 merges the set of physical property values collected during the execution of the current job with the set of physical property values determined to be at the closest distance to the physical property value V acquired before the execution of the job, and updates the physical property value data 61.

On the other hand, when determining that the mediums 9 are not of the same type, the determination section 63 determines that there is a possibility that the process conditions applied during execution of the current job might not be appropriate. In this case, the determination section 63 performs a significant difference test by comparing the physical property value distributions collected during the execution of the current job with the physical property value distributions of other types of medium 9 stored in the physical property value data 61. As a result, if there is a physical property value distribution with no significant difference among the physical property value distributions of the other types of medium 9, the determination section 63 determines that the physical property value distribution with no significant difference and the physical property value distributions collected during the execution of the current job are the same type of medium 9. Then, the determination section 63 merges the set of physical property values collected during the execution of the current job with the set of physical property value distributions determined to have no significant difference, and updates the physical property value data 61. The determination section 63 also reads the process conditions associated with the medium 9 having the physical property value distribution without significant difference and compares the read process conditions with the process conditions applied during the execution of the current job. When there is a difference between the process conditions, the determination section 63 sets one of the process conditions. At this time, the determination section 63 preferably adopts the process condition with a higher process speed, and updates the physical property value data 61 in association with the merged set of physical property values. Job execution efficiency increases as a result of adopting process conditions involving a high processing speed.

If there is no other physical property value distribution that can be determined to have no significant difference from the physical property value distributions collected during the execution of the current job, the determination section 63 identifies that the medium 9 used in the current job is a new medium 9. In this case, the determination section 63 stores a set of physical property values collected during the execution of the current job as physical property value data of the new medium 9. At this time, the determination section 63 updates the physical property value data 61 by associating the process conditions applied in the current job with the physical property value of the new medium 9.

Therefore, when the next job is executed in the image forming apparatus 1, the determination section 63 can identify the process conditions based on the updated physical property value data 61.

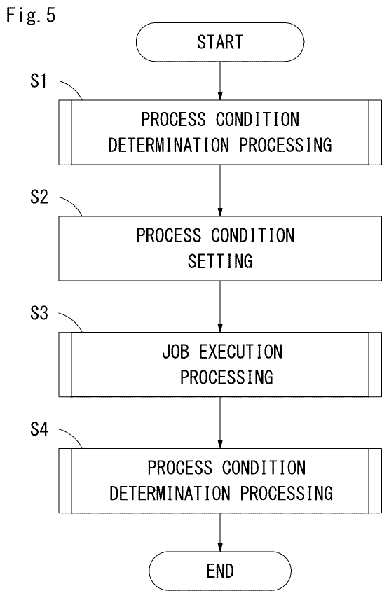

Next, specific operation of the image forming apparatus 1 will be described. FIGS. 5 to 8 are flowcharts illustrating an example of a processing procedure performed by the controller 7. This processing is performed by the CPU 50 of the controller 7 executing the program 60.

When execution of a job is instructed by a user, the controller 7 performs process condition determination processing for identifying process conditions before starting the execution of the job (step S1). When the process conditions are identified by the process condition determination processing, the controller 7 sets the determined process conditions (step S2). That is, the controller 7 sets process conditions corresponding to the medium 9 to be used for execution of the job. Thereafter, the controller 7 performs job execution processing under the set process conditions (step S3). Thus, the job specified by the user is executed in the image forming apparatus 1. When the execution of the job is finished, the controller 7 executes the process condition verification processing (step S4).

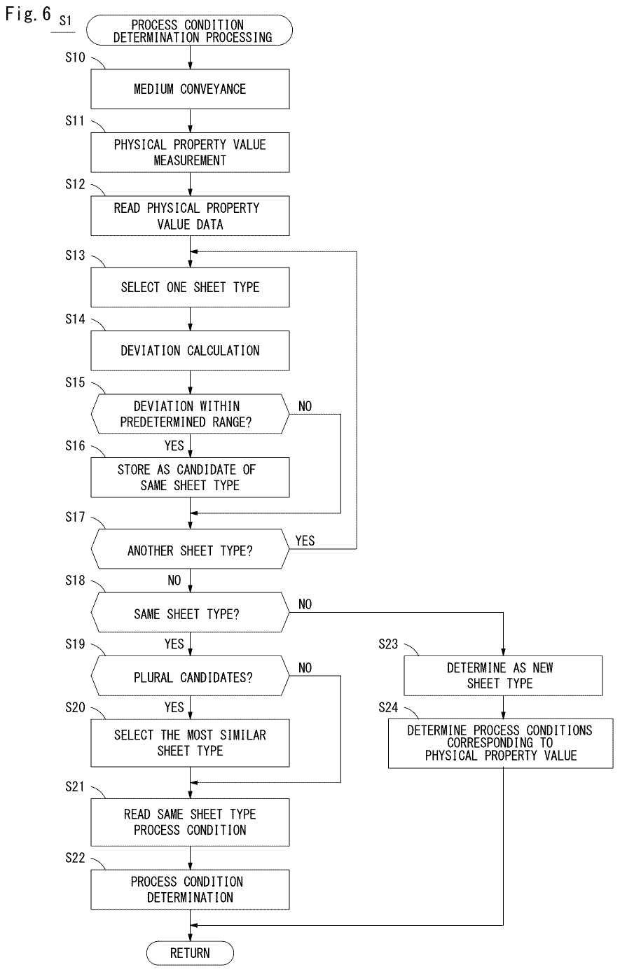

FIG. 6 is a flowchart illustrating an example of a detailed processing procedure of the process condition determination processing (step S1). Upon start of the process condition determination processing, the controller 7 brings the acquisition section 62 into operation. Next, the acquisition section 62 conveys the medium 9 to be used in the job (step S10). At this time, the controller 7 controls the branch section 15 of the measurement unit 20 to switch to a state in which the medium 9 is ejected to the purge tray 16. The medium 9 supplied from the sheet feed unit 10 is carried into the measurement unit 20, and sequentially passes through the measurement sections 21 and 22. The acquisition section 62 drives the measurement sections 21 and 22 to measure the physical property value of the medium 9 (step S11). Accordingly, the acquisition section 62 can acquire the physical property value V of the medium 9 used in the job before the execution of the job. The acquisition section 62 may measure the physical property values of a plurality of medium 9 and acquire the average value of the physical property values before starting the execution of the job.

Upon acquiring the physical property value V of the medium 9, the controller 7 causes the determination section 63 to function. The determination section 63 reads the physical property value data 61 in which the physical property values of the mediums 9 used in the past job are accumulated (step S12). Data related to a plurality of types of mediums 9 are accumulated in the physical property value data 61. The determination section 63 selects one type of the medium 9 from the plurality of types stored in the physical property value data 61 (step S13). Then, the determination section 63 calculates the deviation value of the physical property value V in the physical property value distribution of the selected one type of medium 9 (step S14). For example, when selecting the physical property value distribution of the first type K1 illustrated in FIG. 3, the determination section 63 calculates two deviation values, that is, a deviation value of the basis weight and a deviation value of the sheet thickness, as the deviation values of the physical property value V with respect to the physical property value distribution of the first type K1. The determination section 63 identifies whether each of the deviation values of the basis weight and the sheet thickness is within a predetermined range (step S15). The predetermined range in this case is, for example, a range of 30 to 70. In a case where both of the two deviation values of the basis weight and the sheet thickness are within the predetermined range (YES in step S15), the determination section 63 temporarily stores the medium 9 of the type selected in step S13 as a medium candidate of the same type as the medium 9 to be used in the current job (step S16). On the other hand, when at least one of the two deviation values of the basis weight and the sheet thickness is out of the predetermined range (NO in step S15), the determination section 63 does not store the mediums (media) candidate as a media candidate of the same type.

Next, the determination section 63 identifies whether or not information relating to another type of medium 9 is stored in the physical property value data 61 (step S17). When there is another type of medium 9 (YES in step S17), the process by the determination section 63 returns to step S13. The determination section 63 then selects a different type of the medium 9 from the previously selected medium 9. Next, the processing of steps S14 to S16 described above is repeated.

For example, as illustrated in FIG. 3, in a case where the physical property values relating to the mediums 9 of four types K1 to K4 are accumulated in the physical property value data 61, the determination section 63 repeats the processing of steps S14 to S16 for each of the medium 9 of the four types K1 to K4. Accordingly, the determination section 63 calculates the deviation value of the physical property value V with respect to each of the physical property value distributions of the four types of K1 to K4, and selects the medium 9 of which the deviation value is within a predetermined range as the media candidate of the same type. When the processing in steps S13 to S16 has been performed on all the types of the medium 9 accumulated in the physical property value data 61, the processing by the determination section 63 proceeds to the next step.

Then, the determination section 63 identifies whether or not media candidates of the same type are stored (step S18). When the media candidates of the same type are stored (YES in step S18), the determination section 63 identifies whether or not a plurality of media candidates are stored (step S19). If a plurality of media candidates are stored (YES in step S10), the determination section 63 selects, from among the plurality of media candidates, a medium 9 of a type most similar to the medium 9 having the physical property value V (step S20). For example, the determination section 63 selects one medium candidate whose deviation value calculated in step S14 is closest to 50, and identifies that the medium candidate is the same type as the medium 9 used in the job. When only one medium candidate is stored, the determination section 63 selects the one medium candidate.

Then, the determination section 63 reads the process condition associated with the selected medium 9 (step S21), and identifies the read process condition as the process condition at the time of job execution (step S22).

On the other hand, in a case where the medium candidate of the same type is not stored (NO in step S18), the determination section 63 identifies that the medium 9 measured in step S11 is a new medium (step S23). In this case, the determination section 63 identifies process conditions corresponding to the physical property value measured in step S11 (step S24). For example, the determination section 63 compares the basis weight included in the physical property value with a threshold value Th and determines one of the first process condition and the second process condition. The process condition determined in step S22 or S24 is set as a process condition at the time of job execution in step S2.

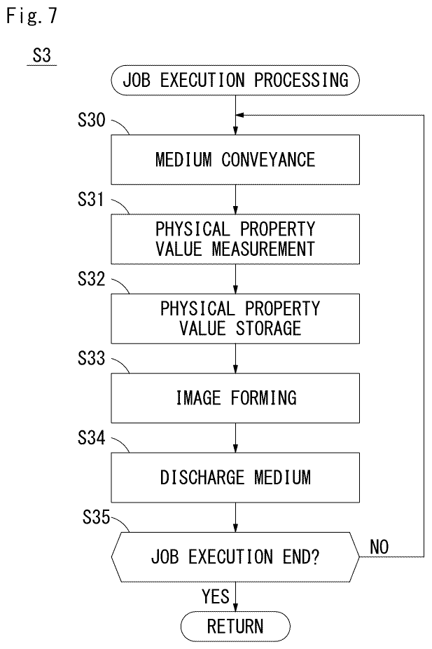

Next, FIG. 7 is a flowchart illustrating an example of the detailed processing procedure of the job execution processing (step S3). When starting the job execution process, the controller 7 causes the job controller 64 and the acquisition section 62 to function. With the start of the execution of the job, the job controller 64 controls the branch section 15 of the measurement unit 20 to switch to a state in which the medium 9 is conveyed to the image forming unit 30. Next, the job controller 64 conveys one sheet of the medium 9 from the sheet feed unit 10 (step S30). When the medium 9 passes through the measurement unit 20, the acquisition section 62 drives the measurement section 21 to measure the physical property value of the medium 9 (step S31). The acquisition section 62 acquires the physical property value and stores them in the storage section 51 (step S32).

The job controller 64 drives the image forming section 31 and the fixing device 32 in accordance with the timing at which the medium 9 is conveyed in the conveyance path 13 of the image forming unit 30, to form an image on the medium 9 (step S33). Then, the job controller 64 conveys the medium 9 on which the image is formed to the sheet ejection unit 40, and discharges the medium 9 to one of the two sheet ejection trays 41 and 42 (step S34).

The job controller 64 identifies whether the execution of the job has been completed (step S35). If the execution of the job has not been completed (NO in step S35), the process by the controller 7 returns to step S30, and the above described process is repeated. That is, the next sheet of the medium 9 is conveyed from the sheet feed unit 10, and the physical property values of the mediums 9 are measured. Then, image formation is performed while the medium 9 is conveyed through the image forming unit 30. The controller 7 repeatedly executes the processing as described above, so that physical property values measured during execution of a job are accumulated in the storage section 51. Then, when the execution of the job ends, the job execution processing ends.

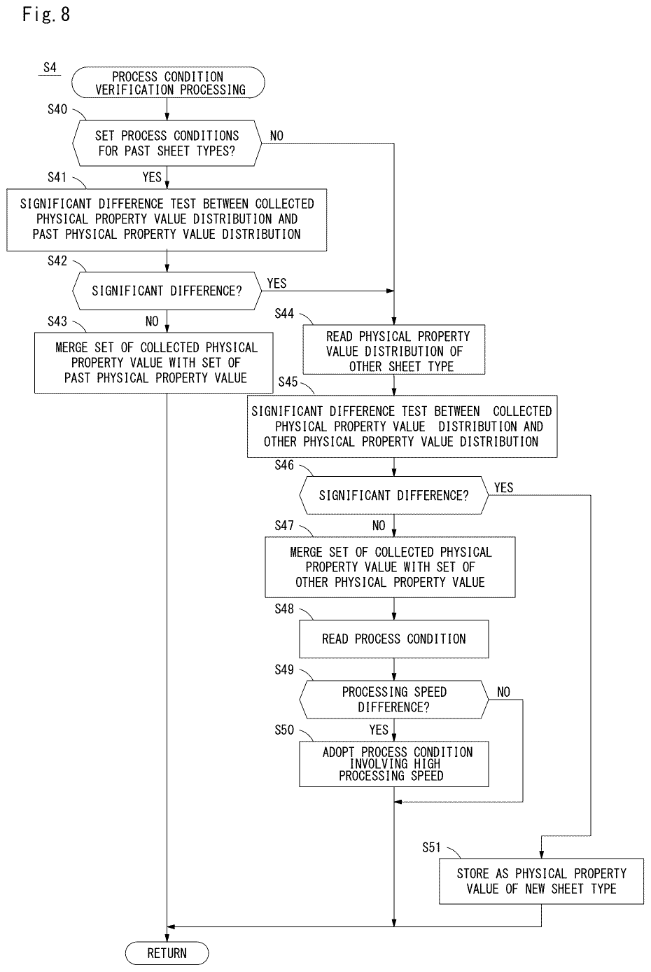

Next, FIG. 8 is a flowchart illustrating an example of a detailed processing procedure of the process condition verification processing (step S4). When starting the process condition verification processing, the controller 7 causes the determination section 63 to function again. The determination section 63 identifies whether or not the process conditions set for the current job are the process conditions set for a past job (step S40). That is, the determination section 63 identifies whether the process conditions set in the current job are the process conditions for the same type of medium 9 recorded in the physical property value data 61. As a result, when the process condition of the medium 9 of the same type is set and the current job is executed (YES in step S40), the determination section 63 reads the physical property value distribution collected during the execution of the current job. Next, the determination section 63 performs a test for significant differences between the physical property value distribution collected during the execution of the job and the physical property value distribution of the same type of the medium 9 recorded in the physical property value data 61 (step S41). The significance level in the significant difference test is set to, for example, 5%. Provided that a level other than 5% may be adopted as the significance level.

In a case where it is determined that there is no significant difference in the significant difference test (NO in step S42), it is confirmed that the medium 9 used in the current job is the same type as the medium 9 selected before the execution of the job. That is, the determination by the determination section 63 before the execution of the current job is correct. As a result, it can be said that the process conditions set in the current job are optimum process conditions for the medium 9 used in the current job. In this case, the determination section 63 merges the set of physical property values collected during the execution of the current job with the set of physical property values of the mediums 9 determined to be of the same type, and updates the physical property value data 61 (step S43).

If the difference is determined to be significant (YES in step S42), it is highly probable that the medium 9 used in the current job is not of the same type as the medium 9 selected before the execution of the job. Therefore, the determination section 63 executes the processing of step S44 and the subsequent steps in order to determine whether or not the medium 9 used in the current job is of the same type as another type of medium 9 recorded in the physical property value data 61. In addition, when the process condition of the medium 9 used in the past is not set at the time of execution of the current job (NO in step S40), the determination section 63 executes the processes of step S44 and the subsequent steps.

The determination section 63 reads the physical property value distribution of the other types of mediums 9 recorded in the physical property value data 61 (step S44). Next, the determination section 63 performs a significant difference test between the physical property value distribution collected during the execution of the current job and the physical property value distribution of the other mediums 9 (step S45). The significance level in this case is also set to, for example, 5%. When the physical property value distributions of a plurality of mediums 9 are recorded in the physical property value data 61, the determination section 63 performs a significant difference test on each of the physical property value distributions of the plurality of medium 9. Next, the determination section 63 identifies whether or not there are significant differences in the significant difference test (step S46).

If there is a physical property value distribution that is determined to have no significant differences in the medium 9 recorded in the physical property value data 61 (NO in step S46), the determination section 63 merges the sets of physical property values into one (step S47). That is, the determination section 63 merges the set of physical property values collected during the execution of the job with the set of physical property values determined to have no significant difference and updates the physical property value data 61. Next, the determination section 63 reads the process conditions associated with the merged set of physical property values (step S48) and compares them with the process conditions set during the execution of the current job (step S49). For example, the determination section 63 compares the processing speeds included in the process conditions and identifies whether there is a difference between the processing speeds.

When there is a difference between the process speeds (YES in step S49), the determination section 63 adopts the process condition with the higher process speed, and updates the physical property value data 61 in association with the merged physical property value (step S50). By adopting the process conditions with the higher processing speed, job execution efficiency is improved when the same type of medium 9 is used in subsequent jobs. When the two process conditions are different from each other, the determination section 63 is not limited to the one that adopts the process condition with a higher process speed. For example, the determination section 63 may adopt the process condition of one of the two sets of physical property values to be merged which has more physical property value data.

If there is no difference in the process speed (NO in step S49), the process conditions associated with the merged set of physical property values match. In this case, the determination section 63 adopts the matching process condition and updates the physical property value data 61 in association with the merged physical property value.

On the other hand, if the medium 9 recorded in the physical property value data 61 include no physical property value distribution that is determined to have no significant differences (YES in step S46), the determination section 63 identifies that the medium 9 used in the current job is a new type of medium 9. In this case, the determination section 63 records the set of physical property values collected during the execution of the current job as the physical property values of the new medium 9 in the physical property value data 61, and updates the physical property value data 61 (step S51). At this time, the determination section 63 stores the process conditions set in the current job in association with the set of physical property values.

As described above, the image forming apparatus 1 according to the present embodiment measures physical property values of the medium 9 to be used in a job, and determines optimum process conditions for the medium 9 based on the measured physical property values. The image forming apparatus 1 executes the job in a state where the determined process conditions are applied, and controls the image forming operation on the medium 9. The image forming apparatus 1 measures a physical property value of the medium 9 conveyed during execution of a job, and stores the physical property value in the physical property value data 61 in association with a process condition. Therefore, the image forming apparatus 1 records and holds, in the physical property value data 61, the physical property value distributions of the medium 9 measured during execution of a past job.

Next, when execution of a job is instructed by a user, the image forming apparatus 1 feeds at least one sheet of the medium 9 specified by the user before starting the execution of the job, and measures the physical property value of the medium 9. Then, the image forming apparatus 1 identifies whether or not the physical property value of the medium 9 measured before the execution of the job is within a predetermined range with respect to the physical property value recorded in the physical property value data 61, and identifies that the medium 9 whose physical property value is within the predetermined range is the same type as the medium 9 used in the current job. The image forming apparatus 1 sets the process conditions associated with the medium 9 determined to be of the same type as the process conditions optimal for the current job.

The image forming apparatus 1 configured as described above can reduce the influence of the measurement error by the statistical analysis even when the physical property value of the medium 9 measured before the execution of the job includes the measurement error. That is, even when the measured physical property value of the medium 9 includes an error, the image forming apparatus 1 can set an optimum process condition for the medium 9. Therefore, the image forming apparatus 1 can appropriately and efficiently form an image on the medium 9 used in the job.

### Second Embodiment

Next, a second embodiment of the present invention will be described. The above described first embodiment has described the example in which the basis weight and the sheet thickness are mainly referred to as the physical property value of the medium 9 in order to identify the process conditions. However, the physical property value to be referred to for identifying the process conditions may be physical property value other than the basis weight and the sheet thickness. In this embodiment, an example in which the process condition is identified with reference to the sheet thickness and the water content will be described.

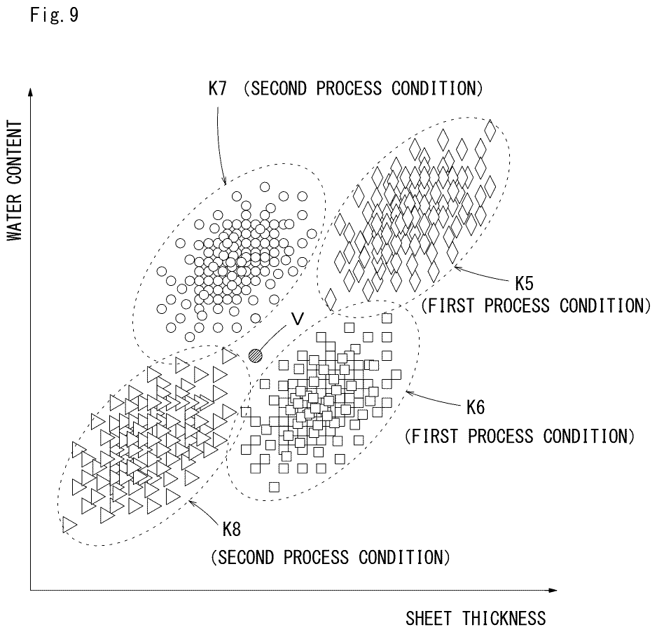

FIG. 9 is a diagram illustrating a physical property value distribution when the sheet thickness and the moisture amount of the medium 9 are measured. In the example of FIG. 9, there are four types of physical property value distributions of K5 to K8, and information relating to four types of medium 9 is shown. In the medium 9 of the first type K5, the first process condition is set at the time of execution of a past job. For the medium 9 of the second type K6, the first process condition is set at the time of execution of a past job. In the medium 9 of the third type K7, the second process condition is set at the time of execution of a past job. The second process condition is set for the medium 9 of the fourth type K8 at the time of execution of a past job.

The image forming apparatus 1 according to the present embodiment conveys at least one sheet of the medium 9 and measures at least the sheet thickness and the moisture content as the physical property value V of the medium 9 before starting execution of a job. At this time, when the physical property value V shown in FIG. 9 is acquired, the image forming apparatus 1 identifies the process condition based on the physical property value V. That is, the image forming apparatus 1 compares the physical property value V with the measured value distributions of the plurality of types K5 to K8, and specifies a measured value distribution within a predetermined range with respect to the physical property value V by the same statistical analysis as in the first embodiment. The image forming apparatus 1 then identifies the medium 9 having the measurement value distribution within the predetermined range to be the same as the medium 9 to be used in the current job, and identifies the process conditions.

As described above, the image forming apparatus 1 of the present embodiment analyzes the physical property value distribution of the sheet thickness and the water content when identifying the process condition. The physical property value distribution is associated with process conditions at the time of execution of a past job. Therefore, the image forming apparatus 1 can identify optimum process conditions for the medium 9 without referring to the basis weight. Incidentally, in this embodiment, the case where the process condition is identified on the basis of the sheet thickness and the water content was illustrated. However, process conditions can be identified in a similar manner for combinations other than sheet thickness and water content. Therefore, physical property value to be referred to when the image forming apparatus 1 identifies process conditions may be a combination other than the sheet thickness and the water content.

Other configurations and operations in this embodiment are the same as those described in the first embodiment.

### Third Embodiment

Next, a third embodiment of the present invention will be described. The optimum process conditions for forming an image on the medium 9 vary depending not only on the physical property value of the medium 9 but also on environmental conditions such as temperature and humidity. Therefore, in the present embodiment, an image forming apparatus 1 that acquires environment information such as temperature and humidity and identifies process conditions will be described.

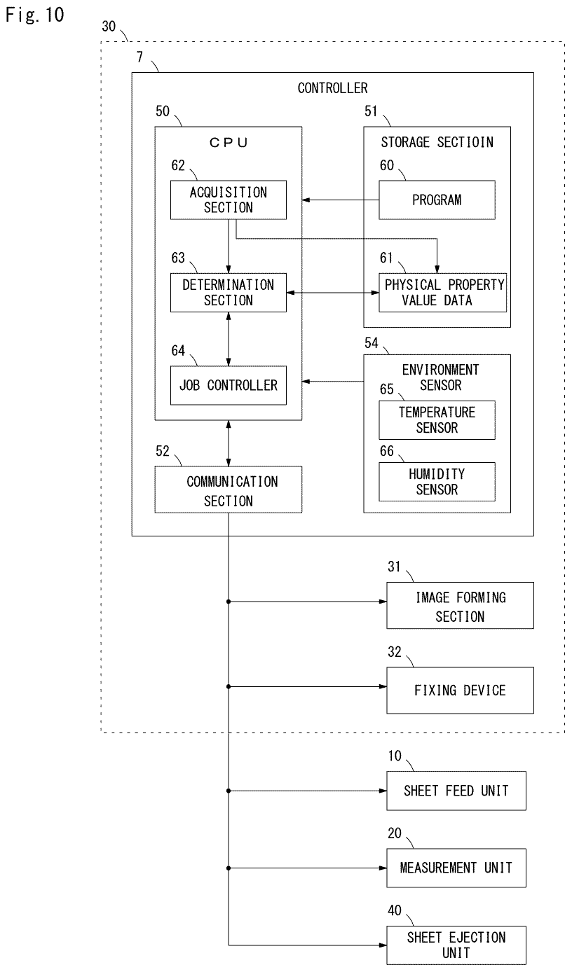

FIG. 10 is a block diagram illustrating the functional configuration of the image forming apparatus 1 according to the present embodiment. The controller 7 of the image forming apparatus 1 includes an environment sensor 54. The environment sensor 54 is a sensor that acquires environment information on an environment in which the image forming apparatus 1 is installed. For example, the environment sensor 54 includes a temperature sensor 65 and a humidity sensor 66. The temperature sensor 65 is a sensor that detects the temperature inside the image forming apparatus 1. The humidity sensor 66 is a sensor that detects humidity inside the image forming apparatus 1. The environment sensor 54 acquires, from the temperature sensor 65 and the humidity sensor 66, environment information including the temperature and the moisture of the environment in which the image forming apparatus 1 is installed, and outputs the environment information to the CPU50. Note that the environment sensor 54 is not necessarily mounted inside the controller 7 and may be a sensor mounted outside the controller 7. Furthermore, the environment sensor 54 may be a sensor installed outside the image forming apparatus 1.

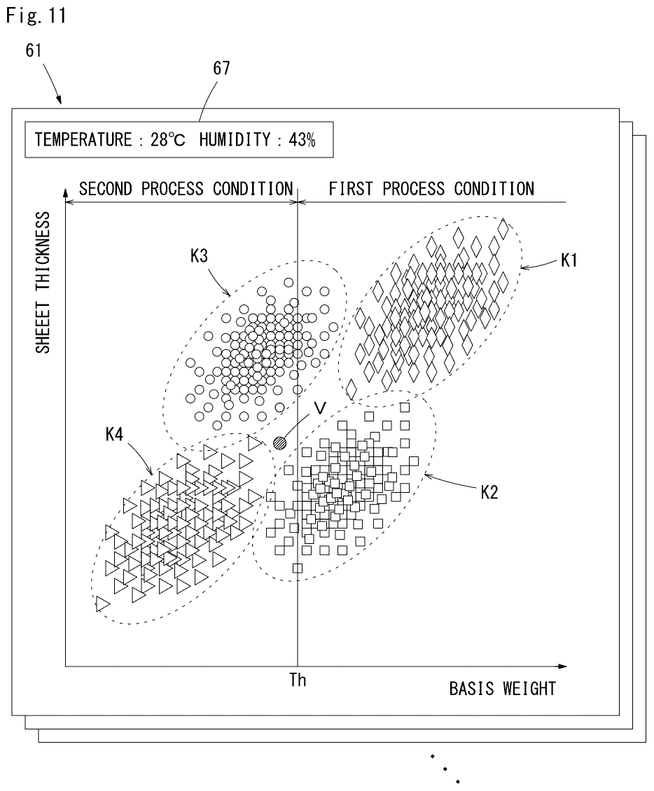

Upon acquiring the physical property value of the medium 9 being conveyed during execution of the job, the acquisition section 62 acquires the environment information from the environment sensor 54. Next, the acquisition section 62 records, in the physical property value data 61, the physical property value of the medium 9 measured during the execution of the job in association with the environment information. FIG. 11 is a diagram illustrating an example of the physical property value data 61 recorded as described above. As shown in FIG. 11, environmental information 67 when the physical property value is measured is associated with the physical property value data 61 of the present embodiment.

When identifying the process conditions before execution of the job, the determination section 63 reads, based on the environment information acquired by the environment sensor 54, the physical property value data 61 acquired under the same environment. In a case where physical property value distributions related to a plurality of types of the medium 9 are recorded in the read physical property value data 61, the determination section 63 identifies which of the plurality of physical property value distributions the physical property value V of the medium 9 measured before the execution of the job is closest to. The determination section 63 then identifies the process conditions associated with the closest physical property value distribution as the process conditions to be applied during execution of the job.

Therefore, the determination section 63 can apply the process condition of the past job executed in the same environment as the environment in which the current job is executed to the current job. At this time, even in a case where an error is included in the physical property value V obtained by measuring the medium 9, the determination section 63 can reduce the influence of the error and set the optimum process condition for the medium 9 by performing the same statistical analysis as in the first embodiment.

As described above, the determination section 63 of the present embodiment acquires the environment information from the environment sensor 54 when a physical property value of the medium 9 is newly measured by the measurement unit 20. Next, the determination section 63 extracts, from the physical property value data 61 stored in the storage section 51, a set of physical property values measured under the same environmental conditions. The determination section 63 identifies whether or not the physical property value of the medium 9 newly measured by the measurement unit 20 is within a predetermined range with respect to the extracted set of physical property values, and identifies the process condition.

Incidentally, environment information such as temperature and humidity in the image forming apparatus 1 varies depending on the season and the month and day. Therefore, the image forming apparatus 1 may be configured to, when the physical property value of the medium 9 is measured by the measurement unit 20, store information on month and date in association with the physical property value. In this case, based on the month and date when the physical property value of the medium 9 are newly measured by the measurement unit 20, the determination section 63 extracts, from the physical property value data 61 stored in the storage section 51, a set of physical property values measured during the same period. Next, the determination section 63 identifies the process condition by identifying whether the physical property value of the medium 9 newly measured by the measurement unit 20 is within a predetermined range relative to the extracted set of physical property values. In this case, the image forming apparatus 1 may not include the environment sensor 54 described above. In addition, the information regarding the month and date may include information regarding time.

Other configurations and operations in this embodiment are the same as those described in the first embodiment.

### Modification Examples

Preferred embodiments of the present invention have been described above. However, the present invention is not limited to the content described in the above embodiments, and various modification examples are applicable.

For example, the above described embodiment illustrates the configuration in which the two measurement sections 21 and 22 are provided in the measurement unit 20. An example of the configuration in which one measurement section 21 of the two measurement sections 21 and 22 is installed in the conveyance path 13 communicating with the image forming unit 30 and the other measurement section 22 is installed in the conveyance path 14 not communicating with the image forming unit 30 has been described. However, the installation positions of the two measurement sections 21 and 22 are not limited to the positions described in the above embodiment. For example, the measurement section 22 may be installed in the conveyance path 13 communicating with the image forming unit 30, similarly to the measurement section 21. In this case, the measurement unit 20 can measure the physical property value of the medium 9 conveyed during the execution of the job with both of the measurement sections 21 and 22. Therefore, the image forming apparatus 1 can acquire various physical property values during execution of a job and record the physical property values in the physical property value data 61. Therefore, when identifying process conditions before execution of a job, the image forming apparatus 1 can identify optimum process conditions for the medium 9 on the basis of various physical property values.

In the above-described embodiment, the case where the program 60 to be executed in the CPU50 of the controller 7 is stored in the storage section 51 in advance has been exemplified. However, the program 60 is not limited to the one stored in the storage section 51 in advance. That is, the program 60 can be a target of trading by itself. Therefore, the program 60 may be provided in a downloadable form via a network such as the Internet, for example. Furthermore, the program 60 may be provided in a state of being recorded on, for example, a non-transitory computer-readable recording medium.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image forming apparatus comprising:
a measurement sensor that measures a physical property value of a medium;
a controller that determines a process condition based on the physical property value measured by the measurement sensor, and controls an image forming operation on the medium by applying the determined process condition; and
a storage that stores the physical property value measured by the measurement sensor and the process condition determined by the controller in association with each other, wherein
upon detecting that the physical property value of the medium newly measured by the measurement sensor is within a predetermined range from the physical property value stored in the storage, the controller identifies the process condition associated with the physical property value within the predetermined range.

2. The image forming apparatus according to claim 1, wherein
the storage stores the physical property value measured by the measurement sensor in association with the process condition determined by the controller while the controller performs the image forming operation on the medium.

3. The image forming apparatus according to claim 2, wherein
the measurement sensor measures physical property values of mediums being conveyed one by one while the controller performs the image forming operation on the mediums, and
the storage accumulates and stores the physical property values of the mediums measured by the measurement sensor while the controller performs the image forming operation.

4. The image forming apparatus according to claim 1, wherein
the measurement sensor measures at least a basis weight of the medium as the physical property value of the medium.

5. The image forming apparatus according to claim 1, wherein
the measurement sensor measures at least two of a basis weight, a thickness, a moisture percentage, and a size of the medium as physical property values of the medium.

6. The image forming apparatus according to claim 1, wherein
the process condition includes at least a process speed.

7. The image forming apparatus according to claim 1, wherein
the controller holds a threshold value for switching the process condition depending on the physical property value of the medium, and identifies whether the physical property value of the medium measured by the measurement sensor is within a predetermined range with respect to the physical property value stored in the storage upon detecting that the physical property value of the medium newly measured by the measurement sensor is within the predetermined range with respect to the threshold value.

8. The image forming apparatus according to claim 7, wherein
in a case where the newly measured physical property value of the medium is within the predetermined range with respect to the threshold value, the measurement sensor measures physical property values of mediums being conveyed one by one while the controller perform the image forming operation on the mediums, and
the storage stores the physical property values of the mediums measured by the measurement sensor while the controller performs the image forming operation, in association with the process condition determined by the controller.

9. The image forming apparatus according to claim 1, wherein
the controller performs a significant difference test between the physical property value of the medium measured while an image is being formed on the medium after the image forming operation is finished and the physical property value associated with the process condition applied during the image forming operation.

10. The image forming apparatus according to claim 9, wherein
upon determining that there is no significant difference in the significant difference test, the controller stores physical property values accumulated during the image forming operation in the storage as the physical property values of a new medium.

11. The image forming apparatus according to claim 9, wherein
upon determining that there is a significant difference in the significant difference test, the controller merges a set of physical property values accumulated during the image forming operation with a set of physical property values associated with the process condition applied during the image forming operation.

12. The image forming apparatus according to claim 1, further comprising:
an environmental sensor that acquires environmental information, wherein
the storage stores the physical property value measured by the measurement sensor, the process condition determined by the controller, and the environmental information acquired by the environmental sensor in association with each other, and
in response to the measurement sensor newly measuring the physical property value of the medium, the controller extracts a set of physical property values measured under the same environmental condition from sets of physical property values stored in the storage based on the environmental information acquired by the environmental sensor, and identifies whether the physical property value of the medium newly measured by the measurement sensor is within the predetermined range with respect to the extracted set of physical property values.

13. The image forming apparatus according to claim 1, wherein
the storage stores the physical property value measured by the measurement sensor, the process condition determined by the controller, and information on a date on which the image forming operation is performed in association with each other while the controller performs the image forming operation on the medium, and
the controller extracts a set of physical property values measured at the same time from sets of physical property values stored in the storage based on a date on which the measurement sensor newly measures the physical property value, and identifies whether or not the physical property value of the medium newly measured by the measurement sensor is within the predetermined range with respect to the extracted set of physical property values.

14. A control method of an image forming apparatus comprising a measurement sensor that measures a physical property value of a medium, the method comprising:
determining a process condition based on the physical property value measured by the measurement sensor;
controlling an image forming operation on the medium by applying the determined process conditions; and
storing, in a predetermined storage, the physical property value measured by the measurement sensor and the determined process condition in association with each other, wherein
upon detecting that the physical property value of the medium newly measured by the measurement sensor is within a predetermined range from the physical property value stored in the storage, the control method identifies the process condition associated with the physical property value within the predetermined range.

15. A non-transitory computer-readable storage medium storing a program to be executed by an image forming apparatus including a measurement sensor that measures a physical property value of a medium, the program causing the image forming apparatus to execute:
determining a process condition based on the physical property value measured by the measurement sensor;
controlling an image forming operation on the medium by applying the determined process condition; and
storing the physical property value measured by the measurement sensor and the determined process condition in a predetermined storage in association with each other, wherein
upon detecting that the physical property value of the medium newly measured by the measurement sensor is within a predetermined range with respect to the physical property value stored in the storage, the image forming apparatus executes identifying the process condition associated with the physical property value within the predetermined range.
